(19) United States
(12) Patent Application Publication
(10) Pub. No.: US 2008/0236422 A1
(43) Pub. Date: Oct. 2, 2008

(54) Pad Printing Machine

(75) Inventor: Holger Reinholdt, Freudenstadt (DE)

Correspondence Address: LOWE, HAUPTMAN, GILMAN & BERNER, LLP (ITW), 1700 DIAGONAL ROAD, SUITE 300, ALEXANDRIA, VA, 22314, US

(73) Assignee: ITW MORLOCK GMBH, Dornstetten (DE)

(21) Appl. No.: 12/065,288

(22) PCT Filed: Oct. 5, 2006
(86) PCT No.: PCT/IB06/02777

§ 371 Date: Feb. 29, 2008

(30) Foreign Application Priority Data
Oct. 7, 2005 (DE) 10 2005 048 467.0

(51) Int. Cl. B41F 17/00; B41F 23/04

(52) U.S. Cl. 101/424.1

(57) ABSTRACT

A pad printing machine designed to doubly or multiply print an object. An object support is or can be positioned in stationary manner, at least one pad carrier carrying at least one pad is configured in displaceable manner relative to the stationary object support, and a drying element drying the printing ink on the object to be printed is configured in displaceable manner relative to the stationary object support.

### BACKGROUND

The present invention relates to a pad printing machine as claimed in the preamble of claim 1.

### SUMMARY OF THE INVENTION

The present invention relaters to a pad printing machine designed to print in double or multiple manner an object to be printed resting on an appropriate support and comprising at least one drying element to dry the printing ink on said object and it is characterized in that said object support is stationary or can be moved into a given stationary position, in that at least one pad carrier is configured, together with one pad, in displaceable manner relative to said stationary object support and the object resting on said support, and in that the drying element is configured in displaceable manner relative to the stationary object support and to the object to be printed resting on said support.

A particular embodiment of the present invention is characterized in that the object support, together with the object to be printed resting on it, is stationary at the same site both during printing and during drying and in that the drying element is displaceable relative to the stationary site of the object support and the object to be printed resting on it and a drying position, the drying element, when parked, being such a distance away from the said object's surface to be printed that sufficient clearance is provided to a pad carrier together with the pad, to move between a remote position far from the surface to be printed and a printing position to contact the said surface to be printed, where, in the drying position of said drying element the latter is configured so closely to the print surface of the object to be printed as to effectively dry said ink on said print surface, and a remote position being provided for the pad carrier and its pad which shall be such a distance away from the print surface of the object to be printed that sufficient clearance is provided when said pad carrier and pad are situated in said remote position that said pad carrier and pad shall be freely displaceable between its parking and its drying positions.

Another embodiment of the present invention is characterized in that the drying element is designed as a hot compressed air feed applying compressed air to the ink on the print surface of the object to be printed.

In still another embodiment of the present invention, said compressed air blown through the compressed air feed on the ink on the; print surface of the object to be printed is generated by a hot air blower applying compressed hot air.

The present invention is especially well suited to drying printed ink during double or multiple printing procedures, also to single-operation drying following completion of multiple printing.

### BRIEF DESCRIPTION OF DRAWINGS

FIGS. 1-6 show various topviews of operational states of a pad printing machine of the invention,

FIG. 7 is a sideview of a printing pad machine detail,

FIG. 8 is a sideview of a further detail of said pad printing machine, and

FIG. 9 is a vertical section of a drying element of the invention.

### DETAILED DESCRIPTION OF EMBODIMENTS

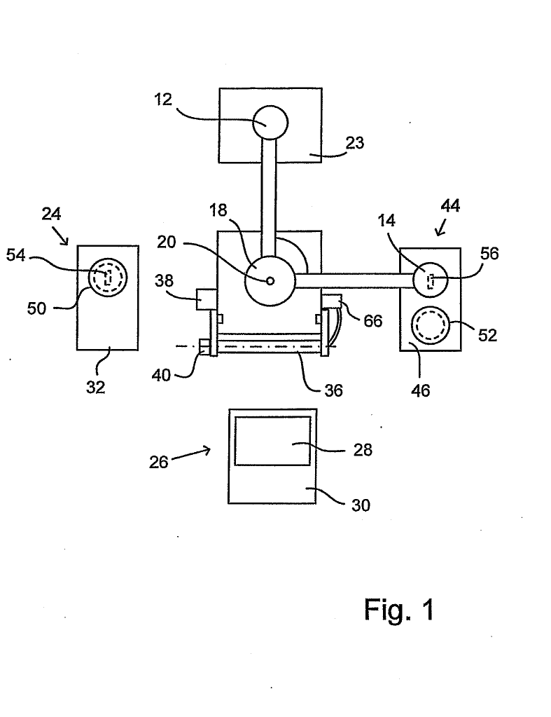

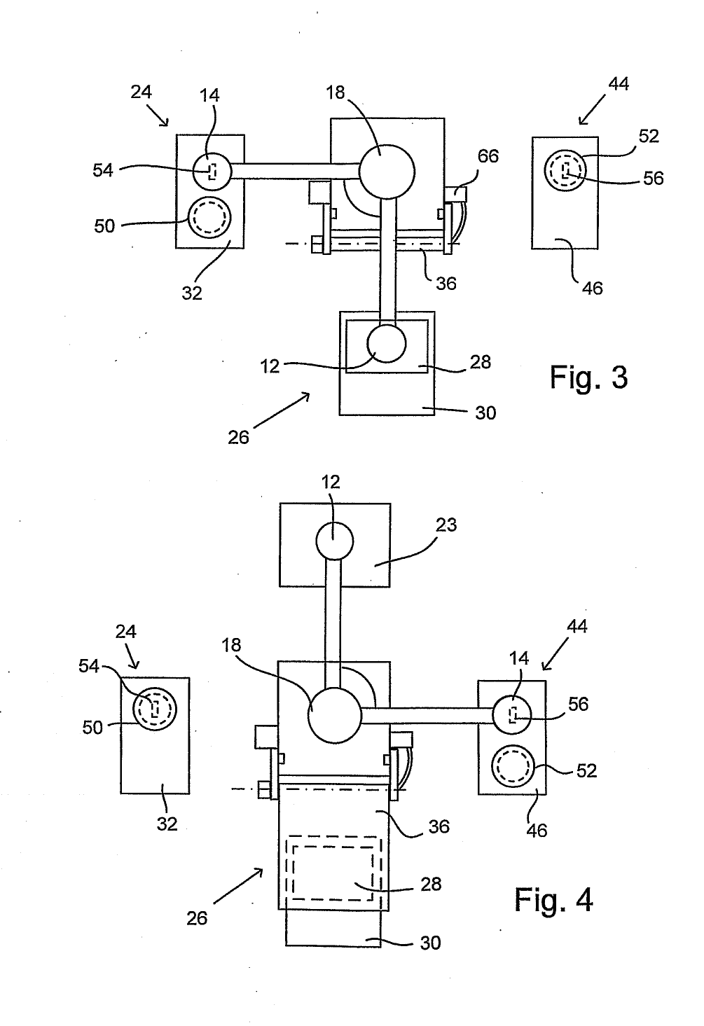

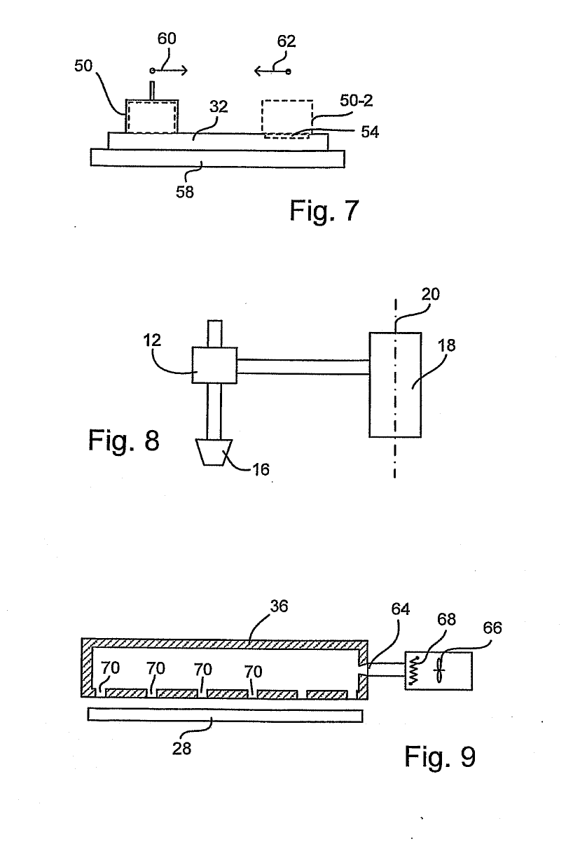

The pad printing machine 2 in topview in FIGS. 1-6 and in detail in FIGS. 7, 8 and 9 illustratively comprises two pad carriers 12 and 14 each holding an appropriately designed pad 16 shown in FIG. 8 and supported in turn by a revolving element 18 which is pivotable about an axis of rotation 20.

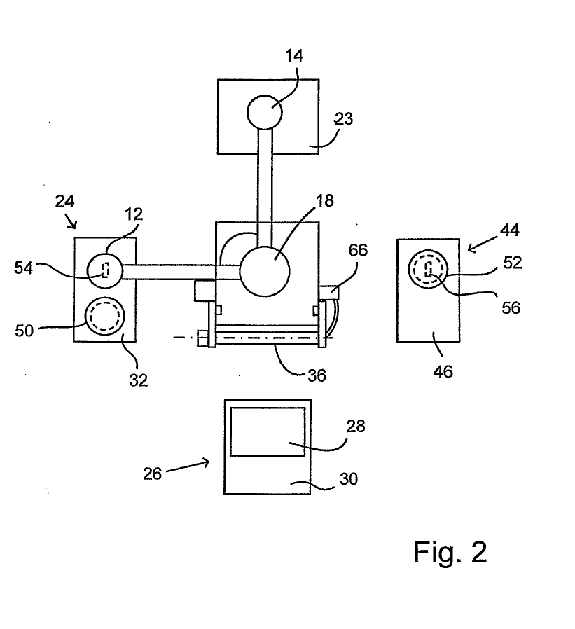

To clean the pad 16, the pad carrier 12 is displaceable between a cleansing position at a cleansing station 23 (FIG. 1), an ink pickup position at a first ink pickup station 24 (FIG. 2) and a printing position 26 above an object to be printed 28 resting on an object support 30. The pad carrier 12 is vertically displaceable at all three stations 23, 24 and 26 to allow cleaning its pad 16 at the cleansing station 23, respectively to pick up ink at the ink pickup station 24 from a cliché plate 32 respectively to transfer ink at the printing station 26 onto the object to be printed 28.

Illustratively and as shown in FIG. 4, the first pad carrier 12 is moved away again from the printing station in a manner that the second pad carrier 14 too shall be absent from this printing station 26. In this manner enough clearance is created wherein a drying element 36 can be moved by a vertical drive 38 and by a rotary drive 40 from a lower vertical parking position shown in FIGS. 1, 2 and 3 into a raised position wherein it can be pivoted into the horizontal drying position shown in FIG. 4. The ink deposited on the object to be printed 18 is dried in the horizontal drying position by the drying element 36.

Following drying, the drying element 36 is moved back by said drives 38 and 40 into the parking position shown in FIGS. 1, 2 and 3. Consequently there is a clearance again to displace the two pad carriers 12 and 14 to allow setting their pads 16 onto the object to be printed 28.

Said drying procedure takes place between two consecutive printing procedures. Such drying also may take place after each printing procedure, or after every second or third printing procedure etc.

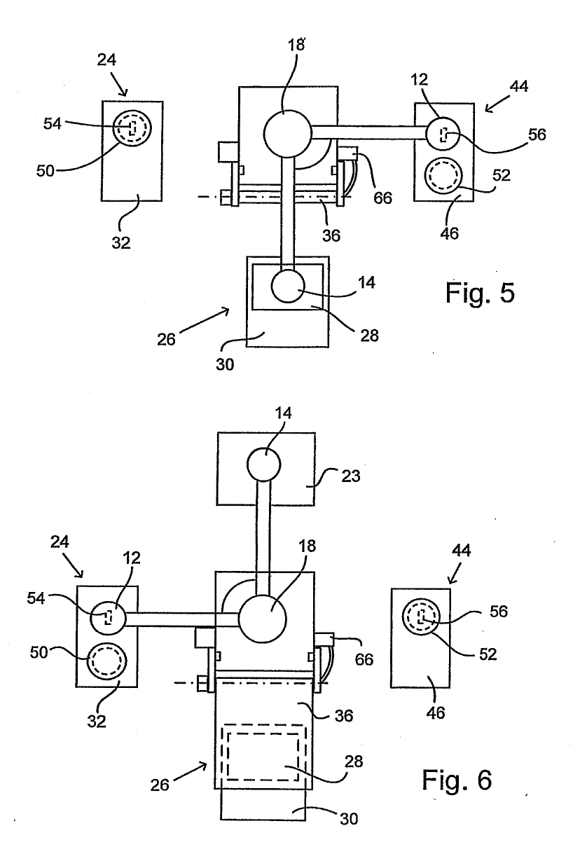

Following such an intermediate drying procedure, the second pad carrier 14—after it has picked up ink from a cliché plate 46 at a second ink pickup station 44 as shown for instance in the position of FIG. 4—is displaced toward the printing station 26 illustratively shown in FIG. 5 in order to deposit at that site the ink on the object to be printed 28 resting on the object support 30.

Thereupon the second pad carrier 14 may be moved away again from the printing station 26, for instance being moved into the cleansing station 23, as a result of which both pad carriers 12 and 14 are situated outside the printing station 26 and a clearance is assured within which the drying element 36 can be displaced above the object to be printed 28 to dry it, as illustrated in FIG. 6. The pad carrier 14 also is vertically displaceable relative to the rotary element 10 for the purpose of moving its pad up and down between the stations.

An ink cup 50 and 52 rests on the respective cliché plates 32 and 46 of the two ink pickup stations 24 and 44 and is displaceable relative to its particular cliché plate. In this manner the picture zone 54 respectively 56 is alternatively covered by the ink cup 50 or 52 to pick up ink from said cup or to be moved into a position adjoining the ink cup 50 or 52 wherein the pad 16 of either pad carrier 12 and 14 is able to pick up the ink. In illustrative manner FIG. 7 shows the ink cup 50 and the cliché plate 32 on a cliché plate rest 58. In the embodiment mode shown, the cliché plate 32 is stationary whereas the ink cup 50 is relatively displaceable to it as indicated by the arrows 60 and 62. The ink cup 50 is shown in solid lines in FIG. 7 next to the picture zone 54, as a result of which one pad can pick up ink, and it is shown by dashed lines 50-2 above the picture zone 54 of the cliché plate 32.

In the preferred embodiment of the invention, the drying element 36 is hollow and fitted with an intake aperture 64 to admit preferably heated compressed air from a blower 66 preferably comprising an electric heater 68 to heat said compressed air. The drying element is 36 fitted with a plurality of outlet apertures 70 allowing blowing the preferably heated drying air onto the ink-covered surface of the object to be printed 28 in the manner schematically shown in FIG. 9.

1. A pad printing machine designed to print in double or multiple manner an object which rests on an object support, and comprising at least one drying element to dry the printing ink on the said object, characterized in that the object support is positioned, or can be displaced to be positioned, in stationary manner, in that at least one pad carrier is displaceable configured together with its pad relative to the stationary object support and to the object to be printed which said support bears, and in that the drying element is configured in displaceable manner relative to the stationary object support and to the object to be printed which said support bears.

2. Pad printing machine as claimed in claim 1, characterized in that the object support together with the object to be printed it bears is positioned in stationary manner both for purposes of printing and drying, and in that the drying element is displaceable relative to the stationary site of the object support and the object to be printed borne by said support between a parking position and a drying position, the drying element when in its parked position being far enough from the object surface to be printed that a pad carrier together with its pad is a provided with enough displacement clearance between a far position away from the surface to be printed and a printing position at which said pad contacts the said surface to be printed, said drying element, when in its drying position, being moved so closely to the print surface of the object to be printed that it dries the printing ink on the print surface of said object to be printed, a far position from the print surface of said object to be printed being provided and used so that, when said drying element is situated in said far position, the pad carrier together with its pad is given enough clearance to be displaceable between its parking position and its drying position.

3. Pad printing machine as claimed in claim 1, characterized in that the drying element is a compressed air feed blowing compressed air on the printing ink of the object to be printed.

4. Pad printing machine as claimed in claim 3, characterized in that a hot air blower is used to generate the said compressed air in the form of hot compressed air that is blown through the compressed air feed onto the printing ink on the print surface of the object to be printed.

5. Pad printing machine as claimed in claim 2, characterized in that the drying element is a compressed air feed blowing compressed air on the printing ink of the object to be printed.
